(19) United States
(12) Patent Application Publication
(10) Pub. No.: US 2008/0122356 A1
(43) Pub. Date: May 29, 2008

(54) PLASMA DISPLAY PANEL

(75) Inventor: Tae-Joung Kweon, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/746,325

(22) Filed: May 9, 2007

(30) Foreign Application Priority Data
Nov. 27, 2006 (KR) 10-2006-0117960

(51) Int. Cl. H01J 17/49; H01J 9/00

(52) U.S. Cl. 313/582; 445/46

(57) ABSTRACT

A plasma display panel includes a front substrate, a rear substrate that faces the front substrate and is spaced apart from the front substrate by a predetermined distance, an address electrode unit that is formed on the rear substrate, and a display electrode unit that is formed on the front substrate. The rear substrate satisfies the following condition: 1.05≦2Lbh/3Lbv≦1.3 where Lbh is a long side length of the rear substrate and Lbv is a short side length of the rear substrate.

### CROSS-REFERENCE TO RELATED APPLICATION

This application claims priority to and the benefit of Korean Patent Application No. 2006-117960 filed in the Korean Intellectual Property Office on Nov. 27, 2006, the entire contents of which are incorporated herein by reference.

### BACKGROUND OF THE INVENTION

1. Field of the Invention

Aspects of the present invention relate to a plasma display panel having address electrodes, display electrodes, and discharge cells that are accurately aligned by enhancing stability of the size of a mother glass, which thereby improves the display quality thereof.

2. Description of the Related Art

Generally, a plasma display panel (PDP) is a display device that can display an image using red, green and blue visible light which is created by exciting phosphors using vacuum ultraviolet (VUV) rays emitted from plasma generated by a gas discharge. Since the PDP can be designed with a large-size screen and provide a high resolution, the PDP has been widely used as a next generation display.

In an alternating current (AC) plasma display panel, address electrodes are formed on a rear substrate. The address electrodes are covered by a dielectric layer. Barrier ribs are arranged on the dielectric layer to define discharge cells and a phosphor layer is formed in each discharge cell. Inert discharge gas is filled in the discharge cells.

In order to manufacture the PDP, there is a need for a process to form electrodes on the front and rear substrates. In a conventional manufacturing method, display electrodes are formed on an individual front substrate and address electrodes are formed on an individual rear substrate. This conventional method yields low productivity, and thus the product cost increases.

Recently, in order to achieve a more efficient mass production method to produce PDPs, a method where the display electrodes and the address electrodes are formed on a large-sized mother glass and the mother glass is subsequently cut into individual front and rear substrates has been used.

A variety of manufacturing processes, such as a backing process and a printing process, are performed in order to form the address electrodes, rear dielectric layer, barrier ribs, and phosphor layers on a rear substrate of the mother glass and to form the display electrodes, front dielectric layer, and protective layer on a front substrate of the mother glass. After the manufacturing processes are performed, the mother glass is cut into the individual front or rear substrates.

Meanwhile, the mother glass is heated during the backing and printing processes. Thus, the mother glass may be thermally deformed or receive thermal stress. As a result, a size of the mother glass may be varied. Specifically, the mother glass is heated up to a temperature higher than a firing temperature during the firing process and is subsequently cooled. At this point, since thermal stress has been applied to the mother glass, the stability of the size of the mother glass deteriorates.

### SUMMARY OF THE INVENTION

Aspects of the present invention provide a plasma display panel having address electrodes, display electrodes, and discharge cells that are accurately aligned with each other by enhancing a size stability of a mother glass, thereby improving the display quality of the plasma display panel. Aspects of the present invention also provide a method of manufacturing the plasma display panel.

According to an aspect of the present invention, a plasma display panel includes a front substrate, a rear substrate that faces the front substrate and is spaced apart from the front substrate by a predetermined distance, an address electrode unit that is formed on the rear substrate, and a display electrode unit that is formed on the front substrate, wherein the rear substrate satisfies the following condition: 1.05≦2Lbh/3Lbv≦1.3, where Lbh is a long side length of each of a pair of first long sides on the rear substrate and Lbv is a short side length of each of a pair of first short sides which are perpendicular to the pair of first long sides on the rear substrate.

According to an aspect, the rear substrate has two horizontal first cutting lines that are respectively formed at the first pair of long sides to be cut along when the rear substrate is cut from a first mother substrate. According to an aspect, the rear substrate has a vertical first cutting line formed at one of the pair of first short sides to be cut along when the rear substrate is cut from the first mother substrate. According to an aspect, the front plate is cut from a second mother substrate and satisfies the following condition: 1.05≦2Lbh/3Lbv≦1.3 where Lfh is a long side length of each of a pair of second long sides the front plate and Lbv is a short side length of each of a pair of second short sides which are perpendicular to the pair of second long sides on the front plate.

According to an aspect, the rear substrate has two horizontal second cutting lines that are respectively formed at the pair of second long sides to be cut along when the front substrate is cut from a second mother glass. According to an aspect, the front substrate has a vertical second cutting line formed at one of the pair of short side sides to be cut along when the front plate is cut from the second mother glass.

According to another aspect of the present invention, a method of manufacturing a plasma display panel includes forming address electrode units on a first mother substrate having a perimeter comprising a pair of first long sides and a pair of first short sides which are perpendicular to the pair of first long sides, a length ratio of one of the first long sides to one of the first short sides ranging from 1.05 to 1.3, forming display electrode units on a second mother substrate having a perimeter comprising a pair of second long sides and a pair of second short sides which are perpendicular to the pair of second long sides, a length ratio of one of the second long sides to one of the second short sides ranging from 1.05 to 1.3, forming first plates by cutting the first mother substrate along a perimeter of each address electrode unit, forming second plates by cutting the second mother substrate along a perimeter of each display electrode unit, and sealing each of the first plates with a respective second plate.

According to another aspect, each of the first and second mother substrates are formed in a rectangular shape. According to another aspect, the address electrode units are arranged on the first mother substrate in a 2×3 pattern so that six of the address electrode units can be arranged on the first mother substrate, wherein the perimeters of the six address electrode units are defined along first cutting lines. According to an aspect, the display electrode units are arranged on the second mother substrate in a 2×3 pattern so that six of the display electrode units can be arranged on the second mother substrate, wherein the perimeters of the six display electrode units are defined along second cutting lines.

According to aspects of the present invention, since the ratio of the long side length of the mother substrate to the short side length of the mother substrate is set to range from 1.05 to 1.3, the stability of the size of the plates formed by cutting the mother substrate can be improved.

In addition, aspects of the present invention reduce the alignment error between the address electrodes, barrier ribs, and display electrodes, thereby improving the display quality of the plasma display panel.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic exploded perspective view of a plasma display panel according to an embodiment of the present invention;

FIG. 2 is a top plane view of a mother glass for rear substrates according to an embodiment of the present invention;

FIG. 3 is a top plane view of the mother glass shown in FIG. 2, when the mother glass is cut into individual substrates;

FIG. 4 is a top plane view of a mother glass for front substrates according to an embodiment of the present invention; and

FIG. 5 is a top plane view of the mother glass shown in FIG. 2, when the mother glass is cut into individual substrates.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

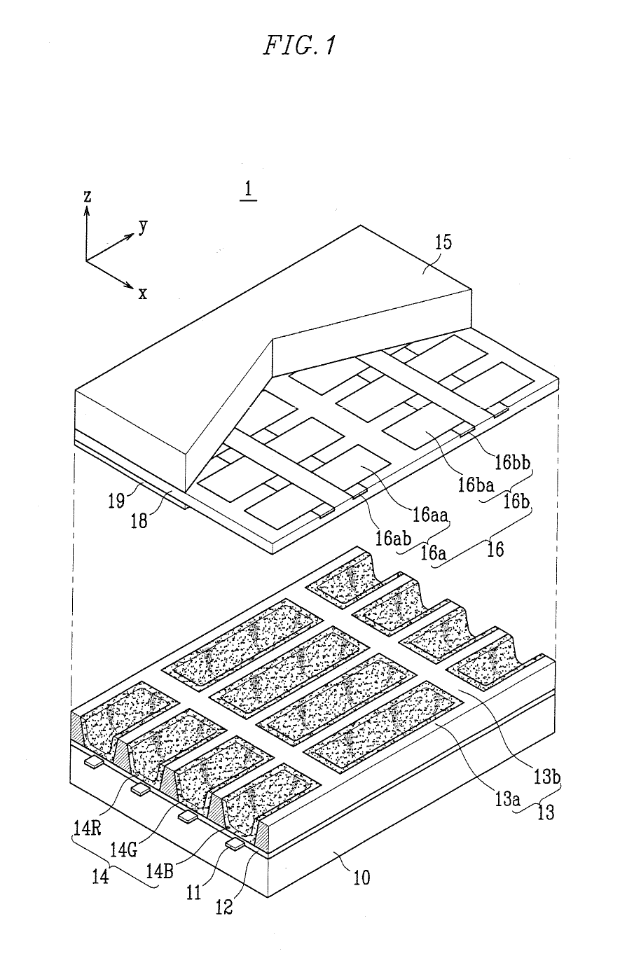

FIG. 1 is a perspective view of a plasma display panel 1 according to an embodiment of the present invention.

Referring to FIG. 1, a plasma display panel 1 includes a rear substrate 10, address electrodes 11, a rear dielectric layer 12, barrier ribs 13, and phosphor layers 14. The plasma display panel 1 further includes a front substrate 15, display electrodes 16, a front dielectric layer 18, and a protective layer 19. It is understood that the plasma display panel 1 may have other components instead of or in addition to those shown in FIG. 1 and described hereinafter.

The rear and front substrates 10 and 15, respectively, are spaced apart from each other by a predetermined distance. The address electrodes 11 are arranged in parallel on an inner surface of the rear substrate 10 and extend in a first direction (along the y-axis in FIG. 1). In addition, the rear dielectric layer 12 is formed on the rear substrate 10 and covers the address electrodes 11.

The barrier ribs 13 defining the discharge cells are formed on the rear dielectric layer 12. The barrier ribs 13 include horizontal barrier ribs 13a extending in a first direction (along the y-axis in FIG. 1) and vertical barrier ribs 13b extending in a second direction (along the x-axis in FIG. 1) perpendicular to the first direction and intersecting the horizontal barrier ribs 13a.

In an embodiment, the barrier ribs 13 define the discharge cells 18 in a matrix pattern. However, the plasma display panel 1 according to aspects of the present invention is not limited to this configuration. The discharge cells 18 defined by the barrier ribs may be arranged in a variety of patterns, such as a stripe pattern or a delta pattern. The barrier ribs 13 function to prevent a cross talk between the discharge cells and provide a space on which the phosphor layers 14 are formed.

The phosphor layers 14 are formed in the discharge cells, i.e., on the barrier ribs 13 and the front dielectric layer 18. The phosphor layers 14 may include red, green and blue phosphor layers 14R, 14G, and 14B. It is understood that the phosphor layers 14 may instead have colors other than red, green and blue. The phosphor layers 14 are excited by ultraviolet rays to emit red, green, and blue visible light.

The display electrodes 16 are formed on an inner surface of the front substrate 15 and extend in a second direction intersecting the first direction. Each of the display electrodes 16 includes sustain and scan electrodes 16a and 16b, respectively. Each of the sustain and scan electrodes 16a and 16b includes a transparent electrode 16aa, 16ba and a bus electrode 16ab, 16bb. In addition, the transparent electrode 16aa, 16ba is formed on the bus electrode 16ab, 16bb. It is understood that the display electrodes 16 may have other types of electrodes instead of or in addition to the sustain and scan electrodes 16a and 16b.

The bus electrodes 16ab and 16bb are preferably, but not necessarily, formed of a material selected from the group consisting of Ag, Co, Ru, and Cr/Cu/Cr, which can minimize a voltage-drop and effectively apply a signal voltage to the transparent electrodes 16aa and 16ba. The transparent electrodes 16aa and 16ba may include a material such as indium tin oxide (ITO). It is understood that the bus electrodes 16ab and 16bb are not required to be formed from the group consisting of Ag, Co, Ru, and Cr/Cu/Cr, and that the transparent electrodes 16aa and 16ba are not required to include ITO, and may instead include another material.

The front dielectric layer 18 is formed on an inner surface of the front substrate 15 and covers the display electrodes 16. The front dielectric layer 18 protects the display electrode 16 from the discharge and forms wall charges to generate the discharge in the discharge cells.

A protective layer 19 is formed on the front dielectric layer 18. The protective layer 19 may be formed of a transparent material such as MgO. The protective layer 19 formed of the transparent material effectively transmits the visible light emitted from the phosphor layers 14. The protective layer 19 protects the front dielectric layer 18 from the discharge to prevent the front dielectric layer 18 from being damaged. Furthermore, the protective layer 19 increases a secondary electron emission coefficient to reduce a firing voltage.

An image display period of the plasma display panel 1 includes a reset period, an addressing period, and a sustain period. In the reset period, a reset pulse is applied to the scan electrodes 16b. In the addressing period, scan and address pulses are respectively applied to the scan and address electrodes 16b and 11. In addition, in the sustain period, the sustain pulses are applied to the sustain and scan electrodes 16a and 16b. Therefore, in the addressing period, the address discharge occurs. The sustain discharge occurs in the sustain period, thereby displaying an image.

The discharge cells are filled with a discharge gas, for example a gaseous mixture including neon (Ne) and xenon (Xe), to create vacuum ultraviolet (VUV) rays using a gas discharge. It is understood that other discharge gases not using Ne and Xe may also be used in accordance with aspects of the present invention.

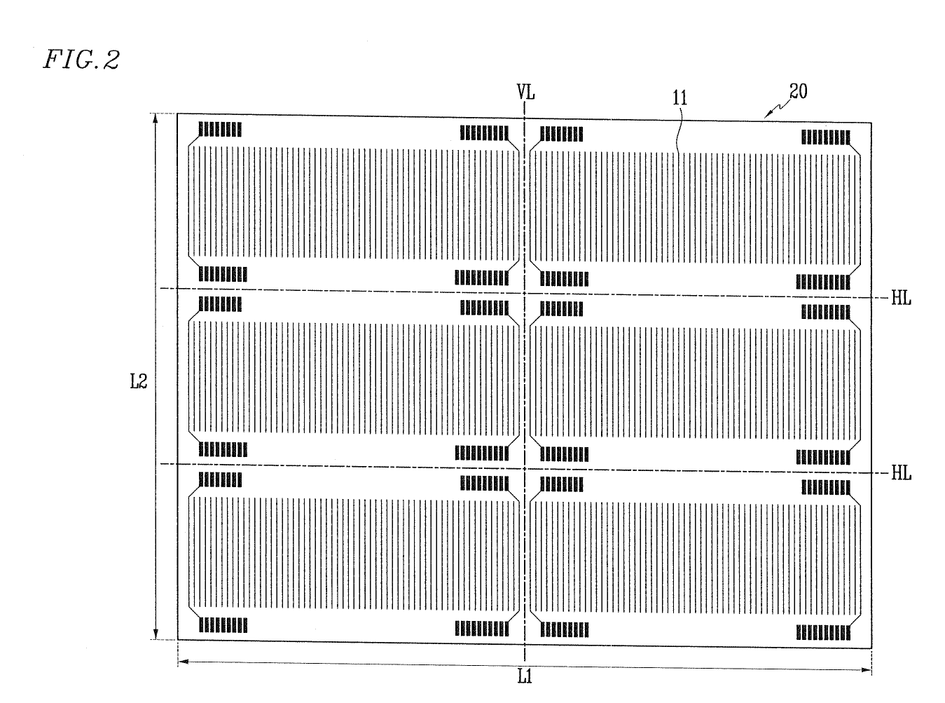

FIG. 2 is a top plane view of a mother glass for rear substrates according to an embodiment of the present invention. In FIG. 2, parts which are illustrated that are not assigned reference numbers refer to those same parts shown in FIG. 1.

Referring to FIG. 2, a mother glass 20 includes a horizontal length L1 and a vertical length L2. The address electrodes 11 are formed on the mother glass 20 and extend in a first direction. The address electrodes 11 may be formed as a unit for forming a single panel. However, it is understood that the address electrodes 11 may instead be formed as sub-units within a single panel, or in other configurations as well. Hereinafter, this unit will be referred to as an address electrode unit. The rear dielectric layer 12, the barrier rib 13, and/or the phosphor layers 14 are also formed on the mother glass 20.

In an embodiment of the present invention, the mother glass 20 is made of glass. However, the present invention is not limited to this embodiment. That is, the mother glass 20 may be formed of materials other than glass, such as plastic.

The mother glass 20 is cut along horizontal and vertical lines HL and VL, respectively, into a plurality of individual rear substrates 10. These horizontal and vertical lines HL and VL are also known as first horizontal and first vertical cutting lines, respectively.

The mother glass 20 is divided into a plurality of sections along the vertical lines VL and the horizontal lines HL. The address electrodes 11 are formed on each section to define the area of the address electrode unit. The address electrodes 11 extend in parallel along the vertical lines VL.

The mother glass 20 is heated up to above a predetermined temperature during the firing process and is subsequently cooled. At this point, since thermal stress has been applied to the mother glass 20 to vary the size of the mother glass 20, the mother glass 20 does not shrink back to its initial size, even when the mother glass 20 is returned to its initial temperature.

The address electrodes 11 are conventionally formed on the motor glass 20 through a screen printing process. At this point, a size of the mother glass 20 is not varied. However, the size of the mother glass 20 is varied as other processes, such as the firing process or the like, are performed, thereby varying the location of the address electrodes 11. To overcome this problem, a method has been developed in an effort to reduce the thermal stress applied to the mother glass 20 which requires slowly increasing and decreasing the temperature used to form the address electrodes 11 on the mother glass 20. However, this method does not sufficiently reduce the thermal stress.

When the horizontal length L1 of the mother glass 20 is substantially greater than the vertical length L2 of the mother glass 20, the thermal deformation in the horizontal direction of the mother glass 20 is relatively greater than that in the vertical direction of the mother glass 20. This thermal deformation causes pitches between the address electrodes 11 to vary.

The rear dielectric layer 12 and the barrier ribs 13 should be formed in response to the location of the address electrodes 11. However, since the location of the address electrodes 11 is not uniform, an alignment error is generated between the address electrodes 11. Specifically, since the deformation is relatively greater at a periphery of the mother glass 20 than at a center portion, the alignment error is also greater at the periphery portion.

In an embodiment of the present invention, in order to reduce the alignment error, a ratio of a long side length of the mother glass 20 to a short side length of the mother glass 20 is set to range from approximately 1.05-1.3:1. The long side length may be one of the horizontal and vertical lengths L1 and L2 and the short side length may be the other of the horizontal and vertical lengths L1 and L2.

If the horizontal length L1 is substantially greater than the vertical length L2, the thermal deformation in the horizontal direction increases, and thus the maximum value of the thermal stress increases. However, according to an aspect of the present invention, since the ratio of the horizontal length L1 to the vertical length L2 is in the proximity of 1, the maximum value of the thermal stress is reduced. Therefore, the stability of the size of the mother glass 20 is improved.

Since the ratio of the long side length of the mother glass 20 to the short side length of the mother glass 20 is set to range from approximately 1.05-1.3:1, the stability of the size of the mother glass 20 is improved, and thus the alignment error of the address electrodes 11 is reduced. When the ratio of the long side length of the mother glass 20 to the short side length of the mother glass 20 is less than 1.05:1, the panels may not be arranged by the desired number of address electrodes 11 and/or a marginal region may unnecessarily exist. When the ratio of the long side length of the mother glass 20 to the short side length of the mother glass 20 is greater than 1.3:1, the thermal deformation in the long side direction increases and thus the maximum value of the thermal stress increases.

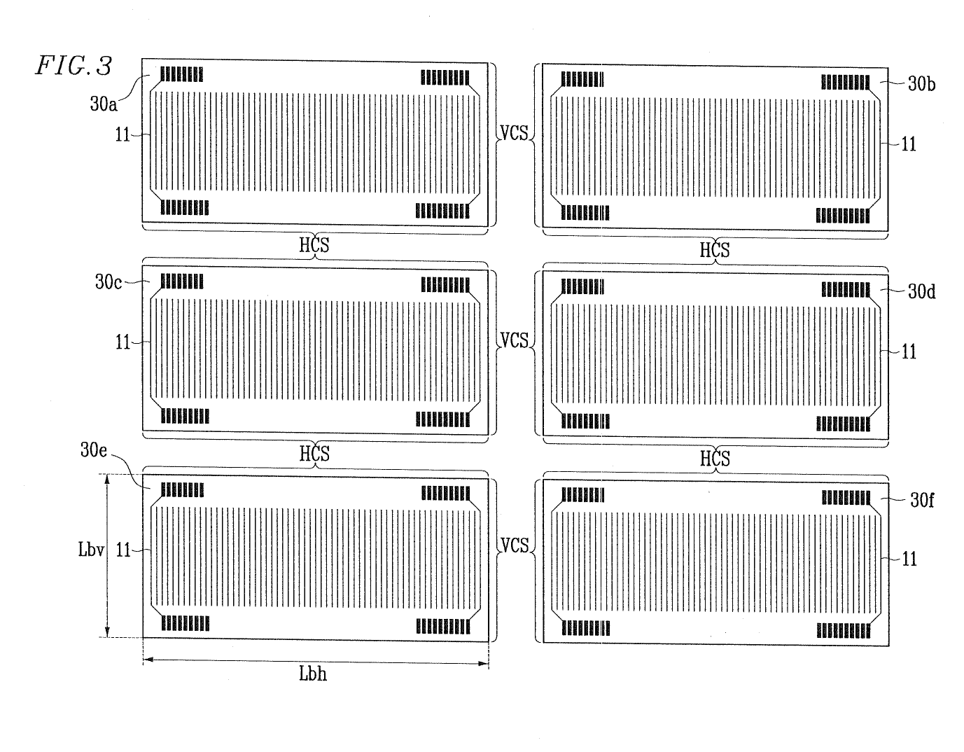

FIG. 3 is a top plane view of the mother glass 20 shown in FIG. 2, when the mother glass 20 is cut into individual substrates. In FIG. 3, parts which are illustrated that are not assigned reference numbers refer to those same parts shown in FIG. 1.

Referring to FIG. 3, when the mother glass 20, also known as a first mother glass or first mother substrate, shown in FIG. 2 is cut along the horizontal and vertical lines HL and VL, the mother glass 20 is divided into six plates 30a to 30f, including an upper-left plate 30a, an upper-right plate 30b, a middle-left plate 30c, a middle-right plate 30d, a lower-left plate 30e, and a lower-right plate 30f. It is understood that the mother glass 20 may instead be divided into more or less than six plates, and that the plates are not required to be rectangular.

The upper-left plate 30a includes one vertical cutting section VCS and one horizontal cutting section HCS which are perpendicular to each other. The upper-right plate 30b also includes one vertical cutting section VCS and one horizontal cutting section HCS that are perpendicular to each other.

The middle-left plate 30c includes two horizontal cutting sections HCS and one vertical cutting section VCS. The middle-right plate 30d also includes two horizontal cutting sections HCS and one vertical cutting section VCS.

The lower-left plate 30e includes one vertical cutting section VCS and one horizontal cutting section HCS which are perpendicular to each other. The lower-right plate 30f also includes one vertical cutting section VCS and one horizontal cutting section HCS that are perpendicular to each other.

That is, each plate 30a, 30b, 30c, 30d, 30e and 30f obtained by cutting the mother glass 20 has at least two cutting sections which are perpendicular to each other.

In an embodiment of the present invention, since the horizontal cutting section HCS is longer than the vertical cutting section VCS, each of the middle-left and middle-right plates 30c and 30d, respectively, includes three cutting sections (two horizontal cutting sections HCS and one vertical cutting section VCS).

The above-described plates are used as rear plates of the plasma display panel 1. The rear plate is designed to satisfy the following condition: 1.05≦2Lbh/3Lbv≦1.3 where Lbh is a long side length of the rear plate and Lbv is a short side length of the rear plate. That is, the address electrode units are arranged on the mother glass 20 in a 2(along a long side)×3(along a short side) pattern. Thus, six address electrode units are arranged on the mother glass 20, and six rear substrates can therefore be cut from the mother glass 20.

Here, the term “substrate” refers to a base plate on which a discharge structure including the address electrodes 11, display electrodes 16, rear dielectric layer 12 and front dielectric layer 18 are formed, and the term “plate” refers to a plate having the discharge structure.

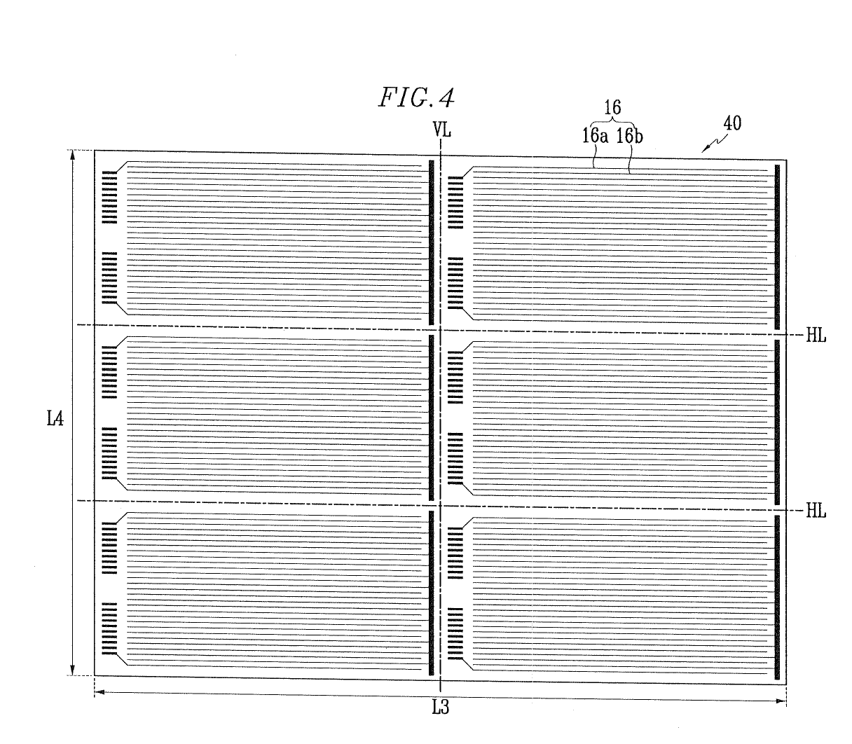

FIG. 4 is a top plane view of a mother glass 40 for front substrates according to an embodiment of the present invention. In FIG. 4, parts which are illustrated that are not assigned reference numbers refer to those same parts shown in FIG. 1.

Referring to FIG. 4, a mother glass 40, also known as a second mother glass or second mother substrate, includes a horizontal length L2 and a vertical length L4. The display electrodes 16 are formed on the mother glass 40 while extending in a second direction substantially parallel to the horizontal lines HL. The display electrodes 16 may be formed as a unit to form a single panel. Hereinafter, this unit will be referred as a display electrode unit. The bus electrodes 16ab and 16bb, the front dielectric layer 18, and/or the protective layer 19 are also formed on the mother glass 40. It is understood that the bus electrodes 16ab and 16bb, the front dielectric layer 18, and the protective layer 19 are not required to be formed on the mother glass 20, and instead may be detachably attached to the mother glass 40 or not connected at all.

The mother glass 40 is cut along horizontal and vertical lines HL and VL, respectively, into a plurality of individual front substrates 15. These horizontal and vertical lines HL and VL are also known as horizontal and vertical second cutting lines, respectively. Before the mother glass 40 is cut, the display electrodes 16 and the like are formed on the mother glass 40. The mother glass 40 is preferably formed of glass, but may also be formed of other transparent materials, such as plastic.

The mother glass 40 is divided into a plurality of sections along the vertical lines VL and the horizontal lines HL. The display electrodes 16 are formed on each section to define the area of the display electrode units. The display electrodes 16 extend in parallel along the horizontal line. As described with reference to FIG. 1, each of the display electrodes 16 includes the sustain and scan electrodes 16a and 16b. However, it is understood that the display electrodes 16 may have other types of electrodes instead of or in addition to the sustain and scan electrodes 16a and 16b.

The mother glass 40 is heated up to above a predetermined temperature during the firing process and is subsequently cooled. At this point, since the thermal stress is formed in the mother glass 40, the mother glass 40 is not returned to its initial size even when the mother glass 40 is returned to its initial temperature. To overcome this problem, a method has been developed in an effort to reduce the thermal stress applied to the mother glass 40 which requires slowly increasing and decreasing the temperature used to form the display electrodes 16 onto the mother glass 40. However, this method does not sufficiently reduce the thermal stress.

The display electrodes 16 are conventionally formed on the mother glass 40 through a screen printing process. During this process, a size of the mother glass 40 does not vary. However, a size of the mother glass 40 does vary as other processes are performed, thereby varying the location of the display electrodes 16. Therefore, pitches between the display electrodes 16 are also varied.

When the horizontal length L4 of the mother glass 40 is substantially greater than the vertical length L3 of the mother glass 40, the thermal deformation in the horizontal direction HL of the mother glass 40 is relatively greater than that in the vertical direction VL of the mother glass 40.

The display electrodes 16 are formed to correspond to the discharge cells formed on the front substrate 10 shown in FIG. 1. However, since the location of the display electrodes 16 is not uniform, an alignment error is generated between the display electrodes 16. Specifically, since the deformation is relatively greater at a periphery of the mother glass 40, the alignment error is also relatively greater at the periphery portion than at a center portion.

In order to reduce the alignment error, a ratio of a long side length of the mother glass 40 to a short side length of the mother glass 40 is set to range from approximately 1.05-1.3:1. The long side length is one of the horizontal and vertical lengths L3 and L4 and the short side length is the other of the horizontal and vertical lengths L3 and L4.

When the horizontal length L3 is substantially greater than the vertical length L4, the thermal deformation in the horizontal direction increases and thus the maximum value of the thermal stress increases. However, since the ratio of the horizontal length L3 to the vertical length L4 is in the proximity of 1, the maximum value of the thermal stress is reduced. Therefore, the stability of the size of the mother glass 40 is improved.

In an embodiment of the present invention, since the ratio of the long side length of the mother glass 40 to the short side length of the mother glass 40 is set to range from approximately 1.05-1.3:1, the stability of the size of the mother glass 40 is improved and thus the alignment error of the display electrodes 16 is reduced. When the ratio of the long side length of the mother glass 40 to the short side length of the mother glass 40 is less than 1.05:1, the panels may not be arranged by the desired number of display electrodes 16 and/or an unnecessary marginal region may exist. When the ratio of the long side length of the mother glass 40 to the short side length of the mother glass 40 is greater than 1.3:1, the thermal deformation in the long side direction increases and thus the maximum value of the thermal stress increases.

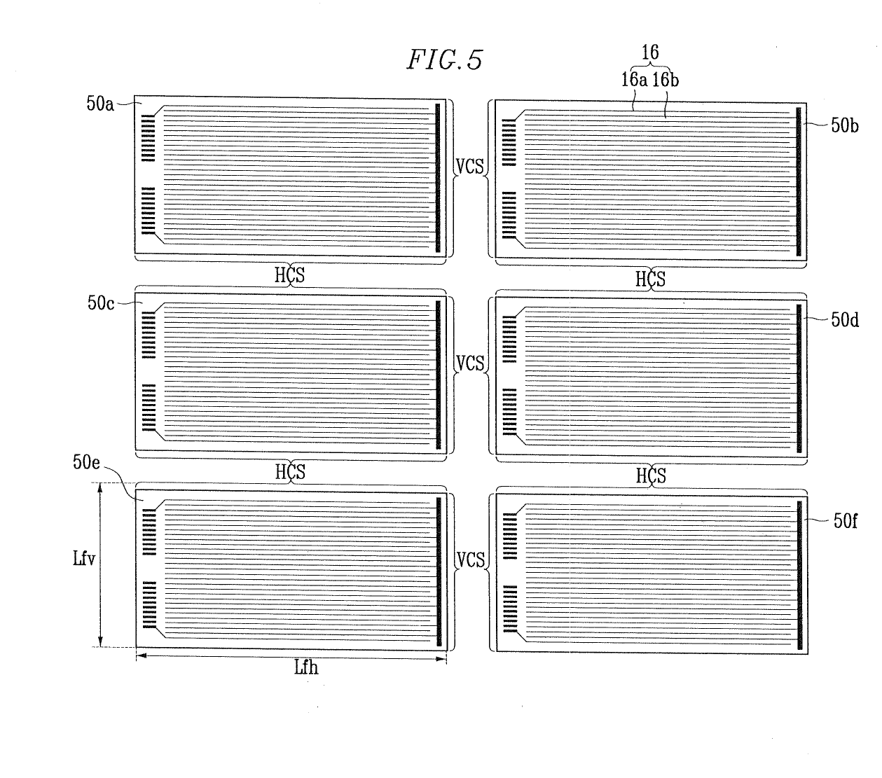

FIG. 5 is a top plane view of the mother glass 40 shown in FIG. 4, when the mother glass 40 is cut into individual substrates. In FIG. 4, parts which are shown that are not assigned reference numbers refer to those same parts shown in FIG. 1.

Referring to FIG. 5, when the mother glass 40 shown in FIG. 4 is cut along the horizontal and vertical lines HL and VL, the mother glass 40 is divided into six plates 50a to 50f including an upper-left plate 50a, an upper-right plate 50b, a middle-left plate 50c, a middle-right plate 50d, a lower-left plate 50e, and a lower-right plate 50f. It is understood that the mother glass 40 may instead be divided into more or less than six plates, and that the plates are not required to be rectangular.

The upper-left plate 50a includes one vertical cutting section VCS and one horizontal cutting section HCS that are perpendicular to each other. The upper-right plate 50b also includes one vertical cutting section VCS and one horizontal cutting section HCS that are perpendicular to each other.

The middle-left plate 50c includes two horizontal cutting sections HCS and one vertical cutting section VCS. The middle-right plate 50d includes two horizontal cutting sections HCS and one vertical cutting section VCS.

The lower-left plate 50e includes one vertical cutting section VCS and one horizontal cutting section HCS that are perpendicular to each other. The lower-right plate 50f also includes one vertical cutting section VCS and one horizontal cutting section HCS that are perpendicular to each other.

That is, each plate 50a, 50b, 50c, 50d, 50e and 50f obtained by cutting the mother glass 40 has at least two cutting sections which are perpendicular to each other.

Since the horizontal cutting section HCS is longer than the vertical cutting section VCS, each of the middle-left and middle-right plates 50c and 50d includes three cutting sections (two horizontal cutting sections HCS and one vertical cutting section VCS).

The above-described plates 50a, 50b, 50c, 50d, 50e and 50f are used as front plates of the plasma display panels 1. The front plate is designed to satisfy the following condition: 1.05≦2Lbh/3Lbv≦1.3 where Lfh is a long side length of the front plate and Lbv is a short side length of the front plate. That is, the display electrode units are arranged on the mother glass 40 in a 2(along a long side)×3(along a short side) pattern. In other words, six display electrode units are arranged on the mother glass 40.

Although the above description discloses cutting both of the mother glasses 20 and 40 into the six plates, the present invention is not limited to this embodiment, and the mother glasses 20 and 40 may be cut into more or less than six plates. Additionally, the plates are not required to be rectangular, and instead may be various other shapes, such as, for example, an elliptical shape.

The plasma display panel 1 is manufactured by sealing the front and rear plates that are prepared through the above-described process.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel comprising:
a front substrate;
a rear substrate that faces the front substrate and is spaced apart from the front substrate by a predetermined distance;
an address electrode unit that is formed on the rear substrate; and
a display electrode unit that is formed on the front substrate,
wherein the rear substrate satisfies the following condition:
1.05≦2Lbh/3Lbv≦1.3,
where Lbh is a long side length of each of a pair of first long sides on the rear substrate and Lbv is a short side length of each of a pair of first short sides which are perpendicular to the pair of first long sides on the rear substrate.

2. The plasma display panel of claim 1, wherein the rear substrate has two horizontal first cutting lines that are respectively formed at the pair of first long sides to be cut along when the rear substrate is cut from a first mother substrate.

3. The plasma display panel of claim 2, wherein the rear substrate has a vertical first cutting lines formed at one of the pair of first short sides to be cut along when the rear substrate is cut from the first mother substrate.

4. The plasma display panel of claim 3, wherein the horizontal first cutting lines are parallel to each other and perpendicular to the vertical first cutting line, so that the rear substrate is formed in a rectangular shape.

5. The plasma display panel of claim 1, wherein the front substrate satisfies the following condition:
1.05≦2Lbh/3Lbv≦1.3
where Lfh is a long side length of each of a pair of second long sides on the front substrate and Lbv is a short side length of each of a pair of second short sides which are perpendicular to the pair of second long sides on the front substrate.

6. The plasma display panel of claim 5, wherein the front substrate has two horizontal second cutting lines that are respectively formed at the pair of second long sides to be cut along when the front substrate is cut from a second mother substrate.

7. The plasma display panel of claim 6, wherein the front substrate has a vertical second cutting line formed at one of the pair of second short sides to be cut along when the front substrate is cut from the second mother substrate.

8. The plasma display panel of claim 7, wherein the two horizontal second cutting lines are parallel to each other and perpendicular to the vertical second cutting line, so that the front substrate is cut in a rectangular shape.

9. A method of manufacturing a plasma display panel, comprising:
forming address electrode units on a first mother substrate having a perimeter comprising a pair of first long sides and a pair of first short sides which are perpendicular to the pair of first long sides, a length ratio of one of the first long sides to one of the first short sides ranging from 1.05-1.3:1;
forming display electrode units on a second mother substrate having a perimeter comprising a pair of second long sides and a pair of second short sides which are perpendicular to the pair of second long sides, a length ratio of one of the second long sides to one of the second short sides ranging from 1.05-1.3:1;
forming first plates by cutting the first mother substrate along a perimeter of each address electrode unit;
forming second plates by cutting the second mother substrate along a perimeter of each display electrode unit; and
sealing each of the first plates with a respective second plate.

10. The method of claim 9, wherein each of the first and second mother substrates is formed in a rectangular shape.

11. The method of claim 9, wherein the address electrode units are arranged on the first mother substrate in a 2×3 pattern so that six of the address electrode units are arranged on the first mother substrate, wherein the perimeters of the six address electrode units are defined along first cutting lines.

12. The method of claim 11, wherein the first cutting lines comprise:
two horizontal first cutting lines which are parallel to the pair of first long sides and spaced such that a distance between the two horizontal first cutting lines in a direction parallel to the first short sides is the same distance that each of the horizontal first cutting lines is respectively spaced away from a closer one of the first long sides; and
a vertical first cutting line parallel to and spaced equally between the pair of first short sides.

13. The method of claim 9, wherein the display electrode units are arranged on the second mother substrate in a 2×3 pattern so that six of the display electrode units are arranged on the second mother substrate, wherein the perimeters of the six display electrode units are defined along second cutting lines.

14. The method of claim 13, wherein the second cutting lines comprise: two horizontal second cutting lines which are parallel to the pair of second long sides and spaced such that a distance between the two horizontal second cutting lines in a direction parallel to the second short sides is the same distance that each of the horizontal second cutting lines is respectively spaced away from a closer one of the second long sides; and
a vertical second cutting line parallel to and spaced equally between the pair of second short sides.

15. A method of manufacturing plasma display panels, comprising:
forming a plurality of electrode units on a mother substrate having a rectangular perimeter comprising a pair of first long sides and a pair of first short sides, a length ratio of one of the first long sides to one of the first short sides ranging from 1.05-1.3:1;
cutting the mother substrate along perimeters of the plurality of electrode units; and
sealing each of the plurality of electrode units with a corresponding electrode unit cut from another mother substrate.

16. The method of claim 15, wherein the perimeters of each electrode unit have the same rectangular dimensions, and a ratio of a long side of the perimeter to a short side of the perimeter is approximately 1.5:1.
